(19) United States
(12) Patent Application Publication
(10) Pub. No.: US 2015/0333517 A1
(43) Pub. Date: Nov. 19, 2015

(54) SELF FORMING MICROGRIDS

(71) Applicant: SOLANTRO SEMICONDUCTOR CORP., Ottawa (CA)

(72) Inventors: Antoine Marc Joseph Richard PAQUIN, Ontario (CA); Raymond Kenneth ORR, Ontario (CA)

(21) Appl. No.: 14/654,344

(22) PCT Filed: Feb. 19, 2014
(86) PCT No.: PCT/CA2014/050111

§ 371 Date: Jun. 19, 2015

Related U.S. Application Data
(60) Provisional application No. 61/766,290, filed on Feb. 19, 2013.

(51) Int. Cl. H02J 3/14; G05B 11/01

(52) U.S. Cl. CPC H02J 3/14; G05B 11/01

(57) ABSTRACT

Self forming microgrids are disclosed. An electrical microgrid includes multiple power domains and power cables coupling the power domains together. Each power domain includes an intelligent distribution panel, and the power domains are coupled to the power cables through the intelligent distribution panels. An intelligent distribution panel includes sockets, an internal power bus coupled to the sockets, and a controller. The sockets enable connection of the intelligent distribution panel to one or more components within a power domain and to one or more other power domains through respective power connections. Power connections between power domains are through power cables coupled to the sockets. The controller is also coupled to the sockets, to control connectivity of the one or more components and the respective power connections with the internal power bus.

### FIELD OF THE INVENTION

This invention relates generally to electrical power grids and in particular to microgrids formed in locations without a pre-existing electrical utility.

### BACKGROUND

Much of the world still does not enjoy reliable electrical power. This includes remote locations in the developed world and large sections of the developing world. In the developing world, electrical utilities are typically government run monopolies which frequently do not have the necessary governance, expertise and/or capital to create and maintain a reliable, national grid infrastructure.

The advent of relatively inexpensive, renewable power generating sources such as Photovoltaic (PV) panels or wind turbines however, has made small scale distributed electrical generation accessible to the individual home owner, business person or entrepreneur.

### SUMMARY

An aspect of the present disclosure provides an electrical microgrid that includes: a plurality of power domains; and power cables coupling the power domains together. Each of the power domains includes an intelligent distribution panel, and the power domains are coupled to the power cables through the intelligent distribution panels.

The power domains are coupled together in an point to point fashion in an embodiment.

The power domains may include power domains which are autonomously controlled.

The electrical microgrid could be isolated from a utility grid.

In an embodiment, the electrical microgrid also includes: an intelligent grid tie connected to a utility grid; and a further power cable coupled between the intelligent grid tie and one of the power domains.

Each power domain could include at least one of: an electrical load, an electrical generator, and an electrical store, coupled to the intelligent distribution panel of the power domain.

Each intelligent distribution panel of each power domain could include: at least one domain socket for connection to the at least one of an electrical load, an electrical generator, and an electrical store within the respective power domain; at least one grid socket for connection to another power domain through a respective one of the power cables; an internal power bus coupled to the at least one domain socket and to the at least one grid socket; and a controller for switchably connecting the at least one of an electrical load, an electrical generator and an electrical store to the internal power bus through the at least one domain socket and for switchably connecting the respective one of the power cables to the internal power bus through the at least one grid socket.

In an embodiment, each intelligent distribution panel also includes a communications module for enabling communication with any one or more of the at least one of an electrical load, an electrical generator, and an electrical store within the respective power domain, with another one of the power domains, or both within the power domain and with another one of the power domains.

Each of the intelligent distribution panels could control operation of the at least one of an electrical load, an electrical generator, and an electrical storage within its respective power domain responsive to a condition of the electrical microgrid.

Each of the at least one grid socket of each of the intelligent distribution panels could include switches for switchably connecting the internal power bus to a respective one of the power cables.

One of the power cables, coupling together two of the power domains through respective grid sockets of the Intelligent distribution panels of the two power domains, could be isolated from the two power domains by the switches of the respective grid sockets on sensing of a fault condition.

Each of the at least one grid socket of each intelligent distribution panel could also include: current sensors for sensing a grid socket current. The fault condition could then be an overcurrent condition sensed by the current sensors of at least one of the respective grid sockets of the intelligent distribution panels, a current imbalance condition sensed by the current sensors of the respective grid sockets, or a current imbalance condition sensed by the current sensors of one of the respective grid sockets.

In an embodiment, each of the at least one grid socket of each of the intelligent distribution panels includes: a voltage sensor for sensing a grid socket voltage. The voltage sensors of a grid socket, in a power domain that includes an electrical generator, could measure a voltage frequency and phase of a power cable of said plurality of power cables. The controller of the grid socket in that power domain could then synchronize voltage frequency and phase of the electrical generator with the measured frequency and phase of the power cable prior to connecting to the power cable through the switches of the grid socket.

The power domain could wait for a random time interval before attempting to connect to the power cable.

The power cables are of identical rated current carrying capacity in an embodiment.

The power cables could also or instead be of an identical phase type.

An intelligent distribution panel includes: a plurality of sockets to enable connection of the intelligent distribution panel to one or more components within a power domain and to one or more other power domains through respective power connections; an internal power bus coupled to the sockets; and a controller coupled to the sockets, to control connectivity of the one or more components and the respective power connections with the internal power bus.

The intelligent distribution panel could also include a control bus coupled to the controller and to the sockets.

The one or more components within the power domain could include at least one of: an electrical load, and electrical generator, and an electrical store.

In an embodiment, the intelligent distribution panel also includes a communications module for enabling communication with a component of the one or more components within the power domain, with a power domain of the one or more other power domains, or both with a component of the one or more components within the power domain and with a power domain of the one or more other power domains.

The controller could control a socket to isolate a power connection from the internal power bus on sensing of a fault condition. Each socket could include current sensors, coupled to said controller, for sensing a socket current. The fault condition could include: (i) an overcurrent condition sensed by the current sensors of a socket; or (ii) a current imbalance condition sensed by (a) the current sensors or by (b) the current sensors and current sensors of a socket of an intelligent distribution panel in a power domain of the one or more other power domains.

The sockets could include a socket that also has a voltage sensor for measuring a voltage frequency and phase at a power connection of the respective power connections that is connected to a power domain of the one or more other power domains. The voltage sensor is coupled to said controller, and the controller could synchronize voltage frequency and phase of an electrical generator within the power domain with the frequency and phase measured by the voltage sensor prior to connecting the power connection to the internal power bus of the intelligent distribution panel.

The controller could wait for a random time interval before attempting to connect the power connection to the internal power bus.

Each socket could include a current sensor, coupled to the controller, for sensing a socket current.

In some embodiments, the sockets include a socket to enable connection of the intelligent distribution panel to a power connection that includes a power line and a neutral line, in which case the socket could include: a first current sensor for sensing a power line socket current at the socket; and a second current sensor for sensing a neutral line socket current at the socket.

The power connection could include one or more further power lines, in which case the socket could include a respective further current sensor for sensing a respective power line socket current at the socket for each of the one or more further power lines.

The sockets could include a socket to enable connection of the intelligent distribution panel to a power connection that includes multiple power lines, with that socket including a respective current sensor for sensing a respective power line socket current at the socket for each of the multiple power lines.

A socket could include a voltage sensor for sensing a voltage at a power connection of the respective power connections.

Where the sockets include a socket to enable connection of the intelligent distribution panel to a power connection that includes a power line and a neutral line, that socket could include a voltage sensor for sensing a voltage between the power line and the neutral line.

The power connection could include one or more further power lines, and the socket could include a respective further voltage sensor for sensing a respective voltage between each of the one or more further power lines and the neutral line.

The sockets could include a socket to enable connection of the intelligent distribution panel to a power connection that includes multiple power lines, and that socket could include a respective voltage sensor for sensing a respective voltage between respective pairs of the multiple power lines.

### BRIEF DESCRIPTION OF THE DRAWINGS

FIG. 1A is a block diagram of one embodiment of a Self Forming MicroGrid (SFMG).

FIG. 1B is a block diagram of another example SFMG with additional generation and transmission capacity.

FIG. 2 is a schematic diagram of a traditional tree type electrical grid topology.

FIG. 3A is a block diagram of an example Intelligent Distribution Panel (IDP).

FIG. 3B is a schematic diagram of one embodiment of an example domain socket.

FIG. 3C is a block diagram of another embodiment of an example domain socket.

FIG. 4 is a schematic diagram of one embodiment of an example three-phase domain socket.

FIG. 5A is a schematic diagram showing two IDPs, and is useful in illustrating an example fault clearing method in an SFMG.

FIG. 5B is a flow diagram of an example fault clearing method.

FIG. 6A is a flow diagram showing an example power domain connection method.

FIG. 6B is a block diagram of an example power domain with an externally disciplined clock.

FIG. 7 is a block diagram of an example SFMG connected to a main electrical grid.

FIG. 8 is a block diagram of an example Intelligent Grid Tie (IGT).

FIG. 9 is a flow diagram illustrating an example output control method.

FIG. 10 is a flow diagram illustrating an example load shed method.

FIG. 11 is a flow diagram illustrating an example current reduction method.

### DETAILED DESCRIPTION

The present disclosure encompasses a new type of electrical grid called a Self Forming MicroGrid (SFMG).

In an embodiment, Self Forming MicroGrids (SFMGs) are created by combining individual generators, electrical storage and loads into an electrical distribution network. Unlike ordinary microgrids however, SFMGs can grow organically from a single power domain without needing to be tied to a utility grid or requiring a central control authority. SFMGs could eliminate many traditional barriers to the creation of an electrical grid such as large up-front capital investments, deep technical expertise or establishment of a centralized power authority. SFMGs capitalize on local initiative, entrepreneurial instincts and the availability of micro-scale investment capital. SFMGs could operate in a peer to peer fashion without a central controller overseeing the grid. In an embodiment, control functions are distributed across the grid rather than centralized. New power domains could be added to an existing SFMG in a “plug and play” fashion, for example, without requiring manual reconfiguration of the grid. Newly connected power domains could be automatically recognized by the SFMG. SFMGs are self monitoring and self regulating in an embodiment. High levels of power engineering expertise to install and maintain the grid might therefore not be required.

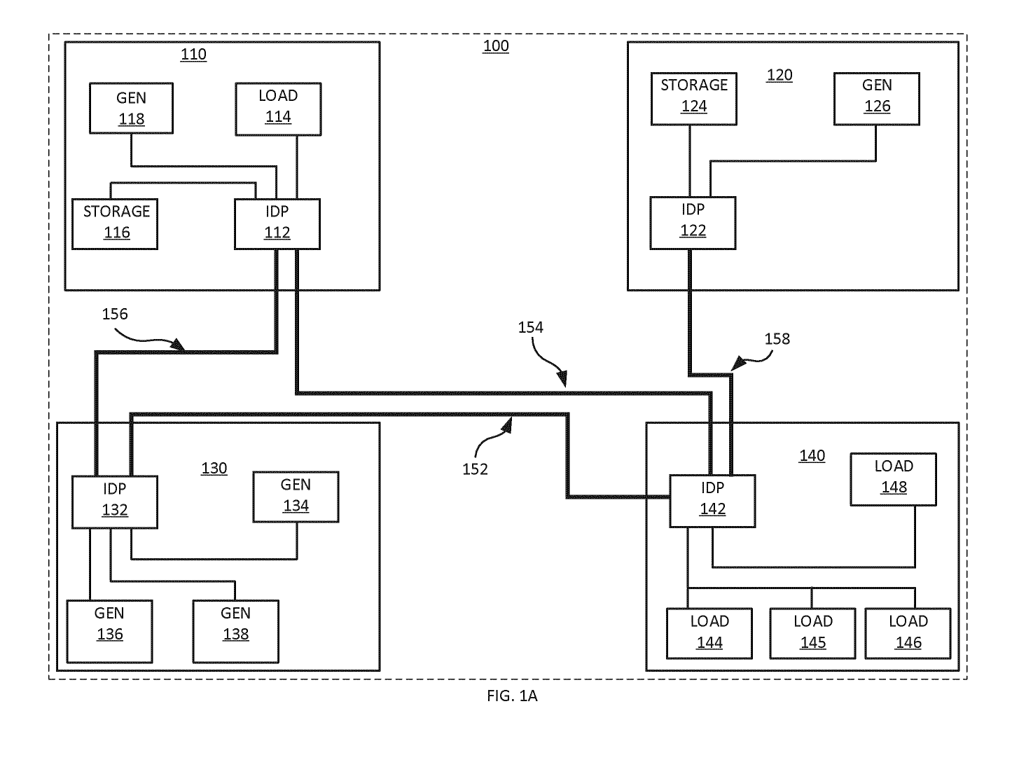

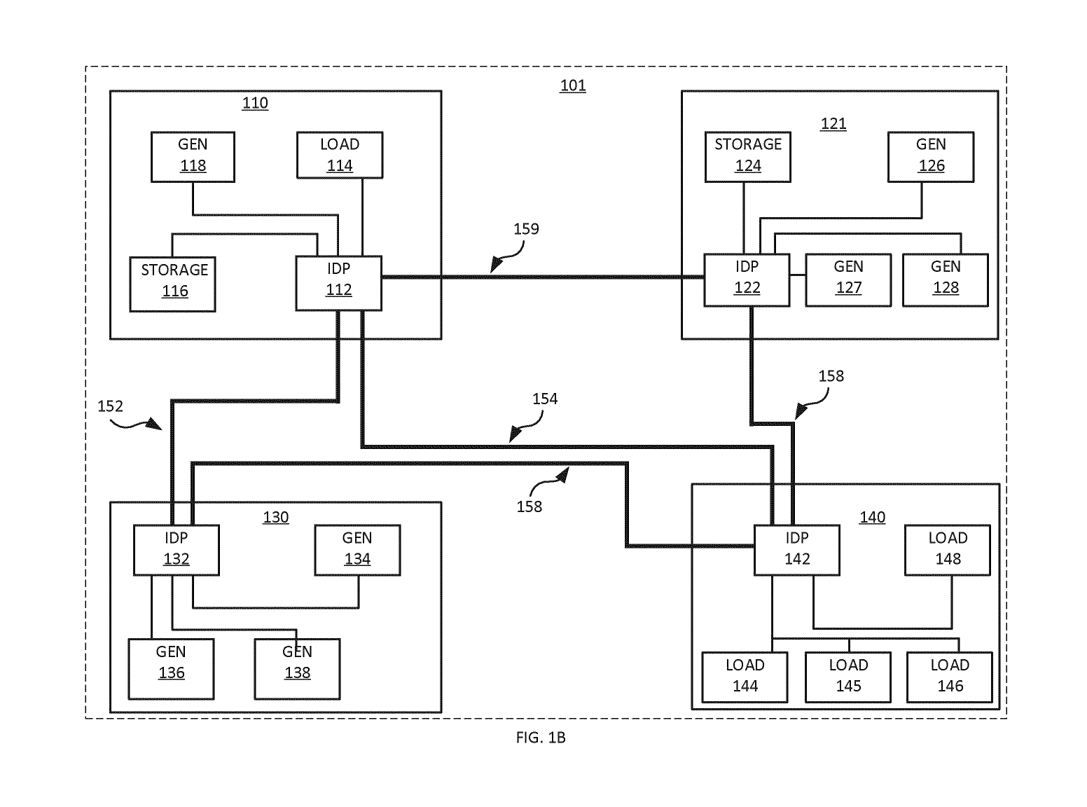

FIG. 1A is a block diagram of one embodiment of an SFMG. The example SFMG 100 includes power domains 110, 120, 130, 140. Power domains in an SFMG may contain any combination of loads, generators and electrical storage devices. Power domain 110, for example, contains load 114, one or more electrical storage device(s) as an electrical store or storage 116, and electrical generator 118. Power domain 130, however, contains electrical generators 134, 136, 138 but no loads or storage devices, and power domain 140 contains loads 144, 145, 146, 148 but no generators or storage devices. Power domain components connect to each other within a power domain, and to adjacent power domains, through an Intelligent Distribution Panel (IDP). Each component within a power domain is coupled to the IDP 112, 122, 132, 142 of that power domain. The power domains 110, 120, 130, 140 each contain an IDP 112, 122, 132, 142, and are coupled to power cables 152, 154, 156, 158 through the IDPs.

Electrical generators within a power domain may include but are not limited to wind turbines, photovoltaic generators, gas turbines and/or diesel generators. Electrical storage devices within a power domain may include but are not limited to batteries, fuel cells, compressed air storage and/or hydraulic storage. Power domain loads may include but are not limited to lighting, water pumps, household appliances, entertainment devices, heaters and/or industrial devices. A power domain in an SFMG might be or include a single family dwelling, an apartment, a small business and/or a temporary structure such as a field hospital, field kitchen, communications facility and/or living quarters.

In an embodiment, power domains 110, 120, 130, 140 are autonomous and independent from other power domains in terms of management or control. Some power domains might also be able to operate even when isolated from other power domains or an SFMG. For example, the power domains 110, 120 include generators 118, 126 and at least storage 116, 124. The power domain 110 also includes a load 114. Such power domains need not be connected to other power domains or an SFMG in order to operate. The power domain 130, for example, includes only generators 134, 136, 138 and could operate without being connected to another power domain that includes a load, although it is unlikely that a generator power domain would be operated if there is no load to be supplied with power. In the power domain 140, the loads 144, 145, 146 could be in an operational state, but would need to be supplied with power from a power source, either a generator or storage, to actually operate. Such a power domain also need not be dependent on any other specific power domain to supply power. Any other power domain with a power source, which could be an electrical store and/or a generator, could supply power to the loads 144, 145, 146, 148.

Thus, a load power domain such as the power domain 140 could still be autonomously controlled in that it need not be centrally managed or controlled in conjunction with any other power domain, even though a power source in another power domain is needed for the loads 144, 145, 146, 148 to operate. The other power domains 110, 120, 130 could also be autonomously controlled, and these power domains might be self-sufficient as well, in that they can operate independently of any other power domain.

The performance and reliability of power domains 110, 120, 130, 140, even if they are autonomous, could potentially be improved by connection to other power domains in an SFMG.

### Connectivity

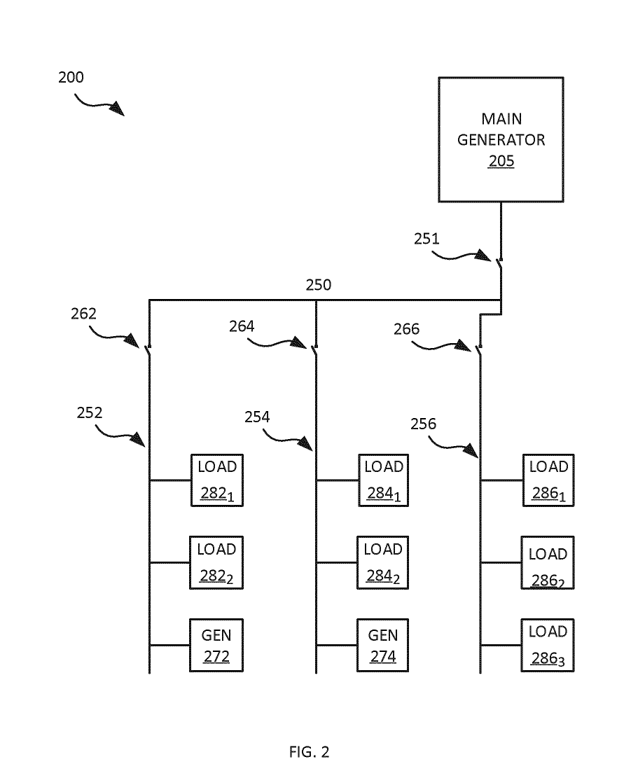

FIG. 2 is a schematic diagram of a traditional tree type electrical grid topology. In traditional grid 200 there is a main power generator 205 which connects to main power bus 250 through a disconnect switch or circuit breaker 251. Power is distributed from main power bus 250 through disconnect switches or circuit breakers 262, 264, 266 to local power buses 252, 254 and 256 and then to loads 282₁, 282₂, 284₁, 284₂, 286₁, 286₂, 286₃ connected to their respective local power buses. In some versions of a traditional grid there are additional, distributed power generators such as 272 and 274 which are connected to local power buses 252 and 254 respectively and supply power to the grid. FIG. 2. is a simplified diagram for illustrative purposes only and some features have been omitted for clarity. For instance, main power bus 250 may be at a higher voltage than local power buses 252, 254 and 256 and various transformer elements could be present to transform the main bus voltage to the local bus voltage(s). Multiple levels of power buses might also be present.

In contrast to the tree structure described above, power domains in an SFMG are coupled together in a point to point fashion in an embodiment. In FIG. 1A for example, power domain 140 connects directly to power domains 120, 130 and 110 through power cables 158, 152 and 154 respectively, and power domains 110, 130 are also directly connected through power cable 156. Power domain 120 however, only directly connects to power domain 140 through power cable 158. Power may still be transferred between power domains that are not directly connected, however, by transferring it through intermediate power domains. For example, power may be transferred between power domains 110 and 120 through the power cables 154 and 158 or through the power cables 158, 152 and 156. Thus, in the example SFMG 100, power domains are connected in a point to point fashion using a mesh type of topology making the SFMG resilient to a single cable or domain/node failure. A mesh topology could be a partial mesh such as shown in FIG. 1A in which at least some power domains directly connect to multiple other power domains, or a full mesh in which all power domains connect to all other power domains. Also, since electrical generation in an SFMG would generally be located closer to electrical loads than in a traditional grid, distribution and transmission capacity requirements, and/or losses, could be reduced.

Power domains in an SFMG may be connected according to the preferences and requirements of the individual power domain owner rather than under the guidance of a grid authority. For example in SFMG 100, power domain 120 includes storage 124 and a generator 126. Power cable 158 connects power domain 120 to power domain 140 and is capable of transmitting power from power domain 120 to power domain 140. If additional generation capacity were added to power domain 120 or the existing generator 126 were able to supply additional loads however, the power domain owner might choose to add an additional cable to connect to another power domain, such as power domain 110.

FIG. 1B is a block diagram of another example SFMG with additional generation and transmission capacity. In example SFMG 101, power domain 121 includes additional generators 127, 128, and has increased generating capacity relative to power domain 120 in FIG. 1A. Power cable 159 now directly connects power domain 121 to power domain 110. IDPs 112, 122 in the example SFMG 101 may have substantially the same structure as in the example SFMG 100 in FIG. 1. In the example SFMG 101, the IDPs 112, 122 include additional sockets, or existing extra sockets which were not used in the example SFMG 100 are connected through cable 159. Sockets in IDPs are discussed in detail below.

Power connections between power domains may be single phase or multi-phase. An example of a multi-phase cable would be a three-phase cable comprising three wires, one for each phase, and a fourth wire for neutral. In one embodiment of the SFMG, cables between power domains are all of an identical phase type. In another embodiment cables between power domains are of all of an identical rated current carrying capacity. These latter embodiments may be beneficial in SFMG applications where technical expertise is limited and may simplify connection of power domains. If desired power transfer capacity between two power domains cannot be met by a single cable then multiple cables could be used.

### Intelligent Distribution Panels

Each power domain has an associated Intelligent Distribution Panel (IDP) which manages the connection(s) between the power domain and other power domains in the SFMG. In FIG. 1A for example, power domains 110, 120, 130 and 140 include respective intelligent distribution panels 112, 122, 132, 142.

In an embodiment, a power domain's IDP also manages power connections within the power domain. For example, referring to FIG. 1A, in power domain 110, generator 118, load 114 and storage 116 all connect through IDP 112. Loads may connect to an IDP individually or via a shared connection. The connection between IDP 142 and load 148 in power domain 140 is an example of an individual connection. An individual connection may be appropriate for a single large load which might destabilize its power domain if it were to turn on in an uncontrolled fashion. Power domain 140 also illustrates an example of a shared load connection in which a group of loads 144, 145, 146 share a single connection to the IDP 142. This type of connection may be appropriate for multiple small loads which are unlikely to all simultaneously switch on and destabilize a power domain. This type of connection may also be appropriate for loads of equal importance or priority which may collectively be shed or given permission to start.

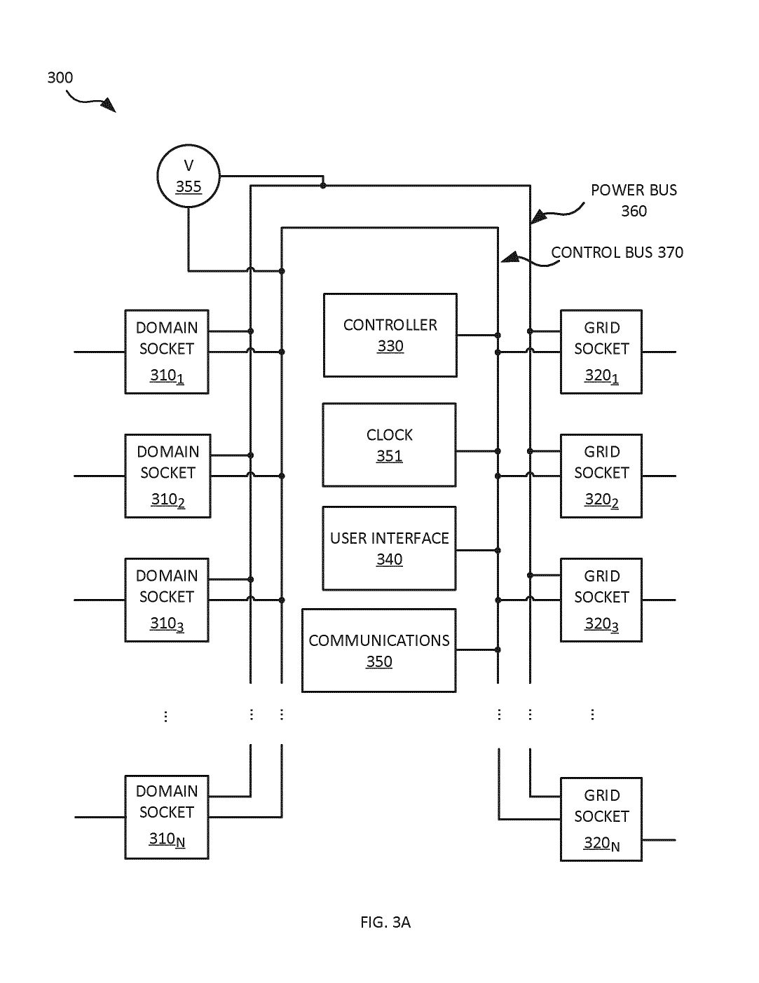

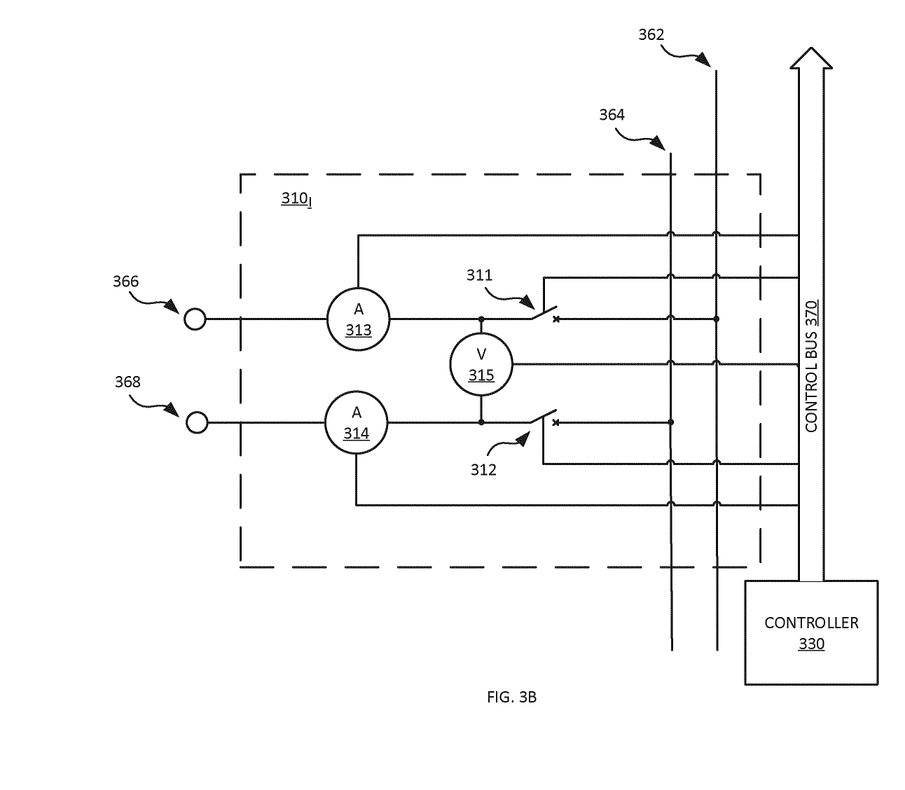

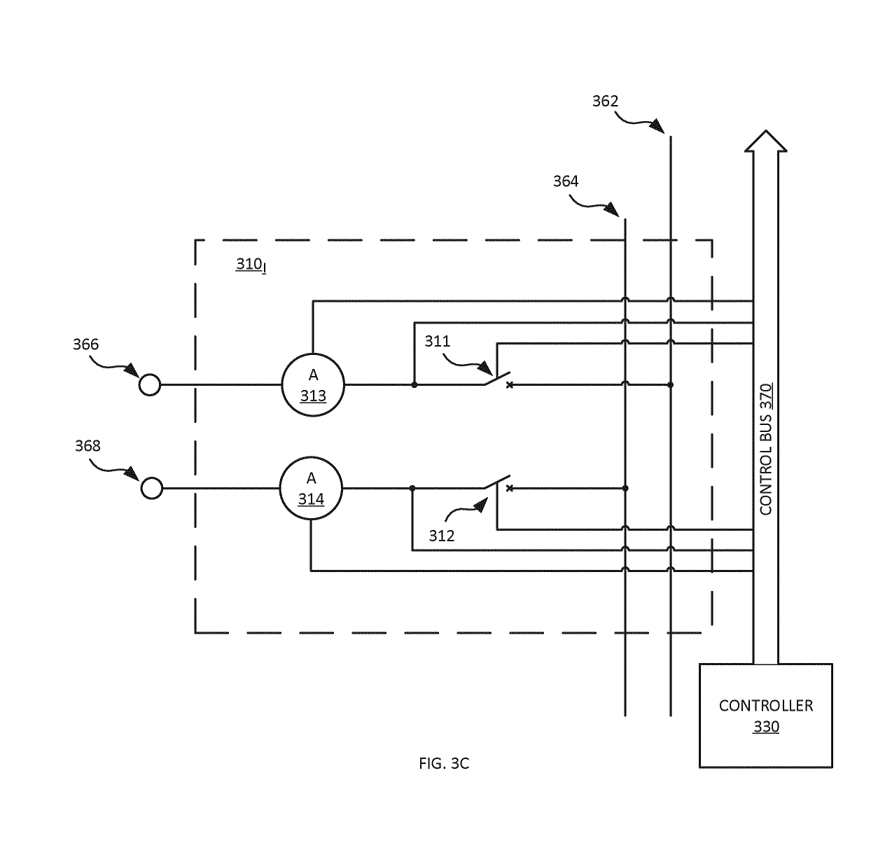

FIG. 3A is a block diagram of an example IDP. Example IDP 300 includes domain sockets 310₁, 310₂, 310₃, . . . 310_{N}, grid sockets 320₁, 320₂, 320₃, . . . 320_{N}, controller 330, clock 351, user interface 340, communications module 350, internal power bus 360 coupled to the sockets, control bus 370, and power bus voltage sensor or sense means 355 such as a voltmeter. The controller 330 is coupled to other components of the example IDP 300 through the control bus 370 in the example shown. Power domain loads, generators and storage devices connect to internal power bus 360 through domain sockets 310₁, 310₂, 310₃, . . . 310_{N}. Other power domains connect to internal power bus 360 through respective power cables and grid sockets 320₁, 320₂, 320₃, . . . 320_{N}.

Connectivity of all sockets, to switchably connect power domain components and/or power cables or connections to the internal power bus, is controlled by controller 330 over control bus 370. Although a control bus is shown in FIG. 3A and in some of the other drawings, some embodiments could support other types of controller communications. For example, the controller 330 could communicate with socket switches and/or with other components wirelessly, through one or more wireless communication links or paths.

Power is transferred between loads, generators and storage within the power domain and between the power domain and other power domains over internal power bus 360. Internal power bus 360 may be single-phase or multi-phase. In one embodiment internal power bus 360 is a single-phase AC bus including a power line and a neutral line. In another embodiment internal power bus 360 is a three-phase AC power bus including three power lines and a neutral line.

### Communications

The example IDP 300 communicates with other components, such as the generators, storage devices, and/or loads in its power domain, through communications module or means 350. In some embodiments the example IDP 300 also communicates with the IDPs in other power domains in the SFMG. Communications may be wired and/or wireless. Wired communications may be through a dedicated line such as an optical fiber or twisted pair and/or it may be over one or more power lines of the internal power bus 360. Wireless communications may be through open communication protocols such as WI-Fi, Wi-MAX, 3G and/or a proprietary protocol. The structure and operation of the communications module 350 will be implementation dependent, consistent with the communication type(s)/protocol(s) to be supported. In general, the communications module 350 enables the example IDP 300 to communicate with one or more power domain components within its power domain, with one or more other power domains, or both.

Communications from the example IDP 300 to power domain generator(s) may include any one or more of: a request to start power generation, a request to stop power generation, a request to vary the generator's active power output, and/or a request to vary the generator's reactive power output, for example.

Communications from power domain generator(s) to the example IDP 300 may include generator operating conditions such as any one or more of: actual power generation, available generating capacity, projections of future generating capacity, generator operating temperature, power generation history and/or total hours of operation, for example. Communications may also or instead include generator parameters such as a device identifier, an in-service date and/or maximum generation capacity, for example.

Communications from the example IDP 300 to power domain storage unit(s) may include any one or more of: a request to output power, a request to store power, a request to vary the amount of output power, and/or a request to vary the amount of power storage, for example.

Communications from power domain storage unit(s) to the example IDP 300 may include storage operating conditions such as any one or more of: amount of stored power, a state of charge, a remaining storage capacity, storage health, operating temperature and/or history, total hours of operation, and/or total number of charge/discharge cycles, for example. These communications may also or instead include storage parameters such as: a device identifier, an in service date, total storage capacity and/or maximum output power.

Communications from the example IDP 300 to power domain load(s) could include, for instance, any one or more of: a request to start up, a request to shut down, and/or a request to vary the amount of power consumption. In some embodiments, load start up and/or shut down could also or instead be controlled by controlling switches in one or more of the domain sockets 310₁, . . . , 310_{N} to connect a load to or disconnect a load from the power bus 360.

A load could also or instead send information to the example IDP 300. Communications from a load to the example IDP 300 may include load operating conditions such as any one or more of: amount of power consumed, load health, projections of future power consumption, operating temperature and/or history, total hours of operation, for example. Load to IDP communications may also or instead include load parameters such as: a device identifier, an in service date, and/or maximum power consumption.

In some applications a load may be a “storage” type load such as a water heater, water tank or freezer. Storage type loads have the ability to store a functional quantity and shift their demand for electrical power. For example, a water tank can fill itself during times of low electrical demand and store the water for later use. Similarly a hot water tank may heat water during a time of low electrical demand and store the heated water for later use. A storage type load might therefore communicate its current storage level to IDP 300.

### User Interface

The example IDP 300 can be configured through User Interface (UI) 340 in an embodiment. Configuration information input to the controller 330 and stored in the controller and/or in one or more separate memory devices (not shown) might include, for example, socket type (e.g. whether a particular socket is to be a grid socket or a domain socket), the nominal SFMG or power domain voltage and frequency, the permissible excursions from those values and/or durations of the excursions. Thus, although domain sockets 310₁, 310₂, 310₃, . . . 310_{N} and grid sockets 320₁, 320₂, 320₃, . . . 320_{N} are shown in FIG. 3A, a socket could be a configurable component which could be configured as either a grid socket or as a domain socket to improve flexibility in building power domains and interconnecting them using IDPs.

Power domain parameters could also or instead be input to controller 330 through UI 340 in an embodiment. These may include, for example: type of device (load, generator, storage) connected to a socket, device parameters (e.g. generating capacity, storage capacity, load value, load priority), and/or device identity (e.g. refrigerator, lighting). Grid parameters may also or instead be input through UI 340 such as the identity of the power domain connected to a grid socket 320₁, 320₂, 320₃, . . . 320_{N}, for example.

The user interface 340 may also or instead be used to enter other general parameters such as the date and time of day, for example.

The user interface 340 may include any one or combinations of any of the following: a keypad, a keyboard, a pointing device, a touch screen, a display, a microphone, an audio speaker, for example.

### Sockets

FIG. 3B is a schematic diagram of one embodiment of an example domain socket suitable for single-phase power. Example domain socket 310_{I} includes switch pair 311 and 312, current sensors 313 and 314 such as ammeters and voltage sensor 315 such as a voltmeter. In this embodiment internal power bus 360 is a single-phase power bus, and includes power line 362 and neutral line 364. Switch pair 311 and 312 connects power line 362 to external power terminal 366 and neutral line 364 to external neutral terminal 368 respectively. Opening and closing of switch pair 311 and 312 is controlled by controller 330 over control bus 370. Current sensors 313 and 314 and voltage sensor 315 couple to controller 330 over control bus 370.

FIG. 3C is a schematic diagram of another embodiment of an example domain socket. In this embodiment the voltage sensor 315 is absent and the voltage sensing function is contained within controller 330. In this embodiment the controller 330 senses the voltage between socket terminals 366 and 368 through connections to control bus 370.

In one embodiment, IDP grid sockets have the same structure as domain sockets.

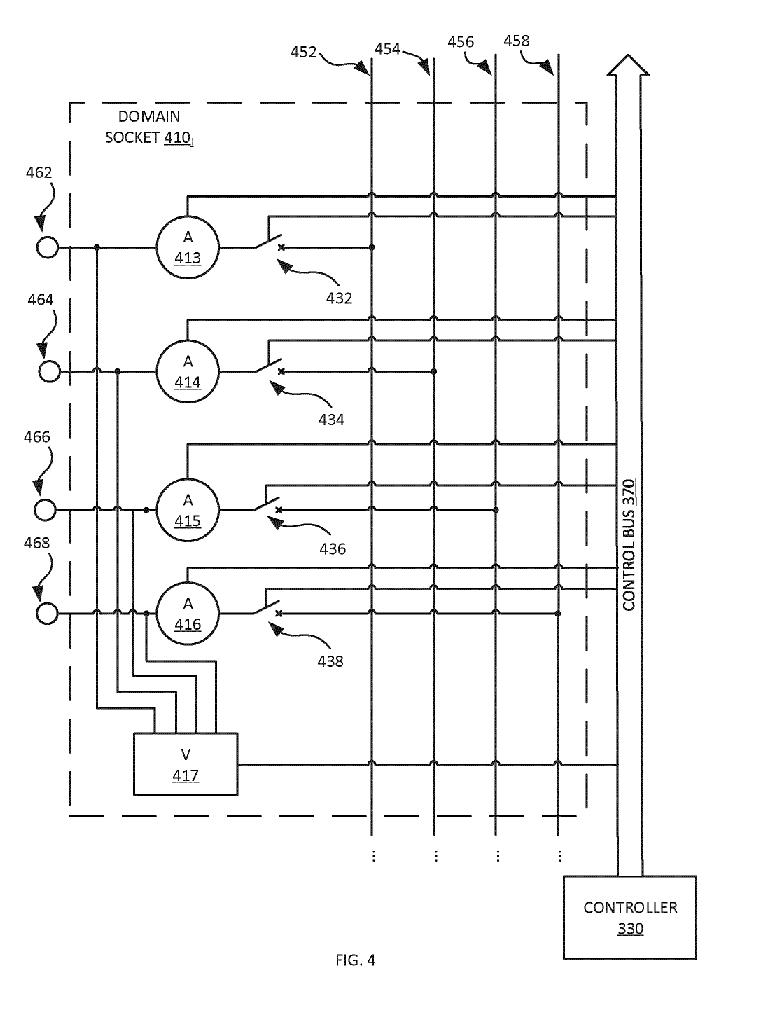

FIG. 4 is a schematic diagram of one embodiment of an example three-phase domain socket suitable for three-phase power. Example domain socket 410, includes switches 432, 434, 436, 438, current sensors 413, 414, 415 and 416, terminals 462, 464, 466, 468 and voltage sensor 417. In this embodiment the internal power bus is a three-phase power bus, and includes neutral line 452 and power lines 454, 456 and 458. Opening and closing of switches 432, 434, 436, 438 is controlled by controller 330 over control bus 370. Current sensors 413, 414, 415 and 416 couple to controller 330 over control bus 370. Voltage sensor 417 monitors the voltages of terminals 462, 464, 466, 468 and couples to controller 330 over control bus 370. In another embodiment the voltage sensor 417 is part of controller 330 and the controller monitors the voltages of terminals 462, 464, 466 and 468 through connections to controller bus 370. In one embodiment, three-phase IDP grid sockets have the same structure as domain sockets.

In another embodiment of a three-phase socket, suitable for a “delta” configuration, the socket is a three-terminal socket and the neutral line and terminal connections are omitted.

In all of these examples, sockets include switches for switchably connecting either power system components (in the case of domain sockets) or power cables (in the case of grid sockets) to the internal power bus of an IDP.

### Fault Clearing

One possible grid function for fault protection is the clearing of faults that may occur in the transmission and distribution network. An example fault would be a short circuit in the transmission network. A short circuit might be from power to ground, between two different phases in a multi-phase system or between power and neutral. Typically a the grid voltage “sags” (decreases below the minimum allowable value) and a large “overcurrent” is drawn when a short occurs in the transmission network.

FIG. 2 is an example illustration of a traditional electrical grid with a main generator and two distributed generators. If a short circuit fault were to occur on local power bus 252, then main grid generator 205 would remain connected despite the voltage sag. It would supply enough current to cause circuit breaker 262 to open, isolating local power bus 252 from the rest of the grid and “clearing” the fault.

Distributed generators 272 might also supply an short circuit current sufficient to cause its internal circuit breaker to open. Alternately it might sense the absence of the main generator 205 on the grid after the opening of circuit breaker 262 and disconnect itself from the local power bus 252. This would prevent local power bus 252 from remaining powered after circuit breaker 262 opens and becoming a power “island”. Power islands are portions of the grid that are isolated from the main grid after a grid fault but are still powered. They are a danger to power workers and are traditionally avoided.

This traditional fault clearing method described above is generally not suited to an SFMG since there is no main grid generator to generate a fault clearing current. Additionally, in the tree type topology of the conventional power grid of FIG. 2 it is relatively simple to position circuit breakers at distribution points in the grid to allow for isolation of a fault. In an SFMG however, power generation is distributed and power can flow in multiple directions in the transmission network. In the mesh topology of FIG. 1B for example, power can flow into cable 156 from any domain in the example SFMG 101 with power generation or electrical storage.

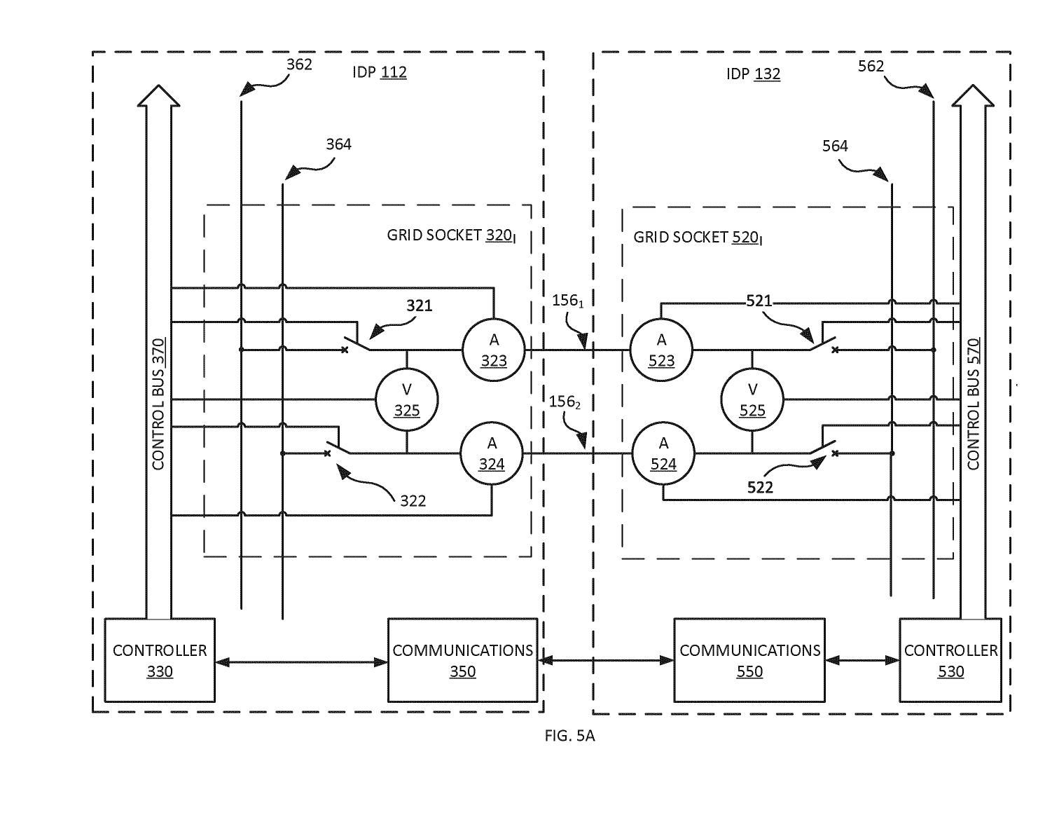

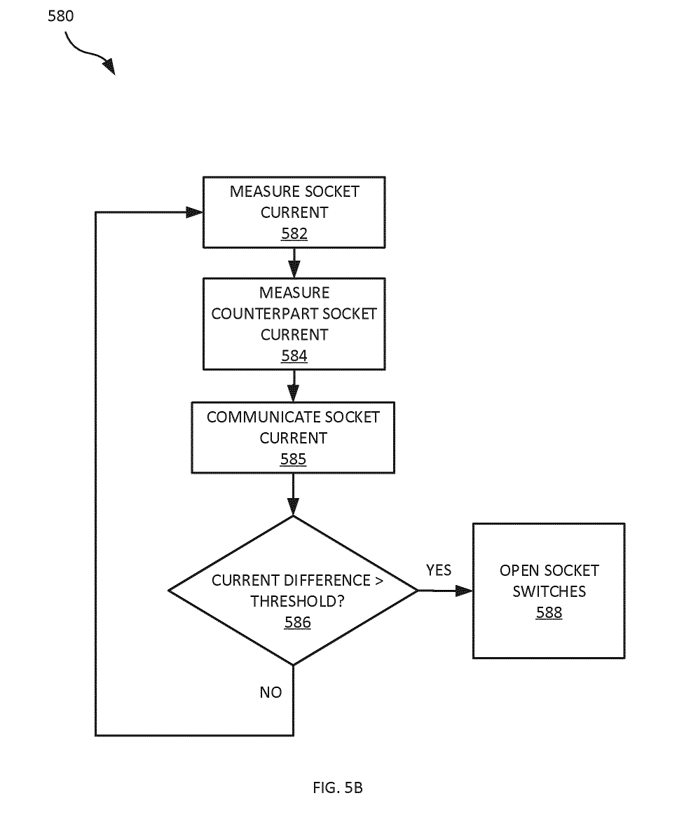

FIG. 5A is a schematic diagram showing two IDPs, and is useful in illustrating an example fault clearing method in an SFMG. Power cable 156 (FIG. 1A) is shown in FIG. 5A as conductors 156₁ and 156₂ connected between IDPs 112 and 132 at grid sockets 320_{I} and 520_{I}. Grid socket 320₁ includes current sensors 323 and 324 such as ammeters, voltage sensor 325 such as a voltmeter, and switches 321 and 322. Grid socket 520_{I} similarly includes current sensors 523 and 524 such as ammeters, voltage sensor 525 such as a voltmeter, and switches 521 and 522. If a short circuit occurs in a cable conductor 156₁, 156₂, then large currents may flow and the voltage at the input to either socket 320_{I}, 520_{I} may also sag. A voltage sag will be sensed by one or both of voltage sensors 325, 525. An overcurrent will be sensed by any of current sensors of 323, 324, 523, 524 depending on the type of short. One or both of controllers 330, 530 will then cause one or both of switch pairs 321/322 or 521/522 to open, isolating one or both ends of the cable conductors 156₁, 156₂.

If both switch pairs 321/322 and 521/522 open, then the fault is entirely isolated. In some situations the fault may only be sensed at one socket 320_{I}, 520_{I} and only one switch pair 321/322 or 521/522 will open, with the remaining switch pair remaining closed. In one embodiment, the closing of a socket switch pair on one cable end is communicated to the IDP on the other cable end and causes the switch pair in the corresponding socket to open. For example, in FIG. 5A, if voltage sensor 325 senses a voltage sag and/or one or both current sensors 323, 324 sense an overcurrent on one or both cable conductors 156₁, 156₂, then controller 330 causes switches 321 and 322 to open. Controller 330 communicates this opening to controller 530 through communications modules or means 350 and 550. Controller 530 then opens switches 521 and 522, completing the isolation of the fault on cable 156.

It is important to note that the fault clearing current in the above scenario is not necessarily generated by a single power domain, but by all power domains in an SFMG that include generation or storage. Referring to FIG. 1A, a fault in cable 152 results in the generation of a fault clearing current not only from the directly connected power domain 130, but also from power domains 120 and 110 which have power sources in the form of generators 118, 126 and storage 116, 124. The fault clearing currents from individual power domains combine in the sockets at either end of cable 152 resulting in an overcurrent and the isolation of the cable as described above.

In another embodiment of fault clearing, a current imbalance between currents in connected grid sockets from different power domains is used to detect a fault condition in the power cable connecting the sockets. As an example, and referring to FIG. 5A, the RMS current in grid socket 320_{I} is measured by one or both of current sensors 323, 324 and compared to the RMS current in grid socket 520_{I} as measured by one or both of current sensors 523, 524. A difference between the two grid socket RMS currents could indicate a fault between conductors 156₁, 156₂. In one embodiment, the RMS current values measured at grid sockets 320_{I}, 520_{I} in IDPs 112, 132 are communicated by communication modules or means 350, 550 to their counterpart IDPs 132, 112. In this embodiment, controllers 330, 530 each compare the grid current measured at their socket (320_{I}, 520I respectively) to the grid current measured at the counterpart grid socket (520_{I}, 320_{I}, respectively). In one embodiment, an RMS current difference larger than a threshold value causes controllers 330, 530 to open switches 321, 322, 521, 522 and isolate the fault.

A current imbalance might also take the form of an imbalance at a socket. As an example, and referring to FIG. 5A, the RMS current in grid socket 320_{I} is measured by both of current sensors 323, 324 and compared. A difference between the two RMS currents could indicate a fault between conductors 156₁, 156₂. In one embodiment, an RMS current difference larger than a threshold value causes controller 330 to open switches 321, 322 and isolate power bus 362, 364 from power cable 156₁, 156₂.

FIG. 5B is a flow diagram of an example fault clearing method. At 582 a socket current is measured. At 584 the socket current in the counterpart socket is measured. At 585 the counterpart socket current is communicated. At 586 the difference between the two currents is compared to a threshold value. If the difference is larger than the threshold value, then the socket switches are opened at 588. Otherwise, a measurement and comparison cycle is repeated.

Although the measurements at 582, 584 are shown in FIG. 5B in sequence for illustrative purposes, the current measurements need not be performed in any particular order and could be performed at substantially the same time and/or on an ongoing basis to continuously or periodically monitor socket currents. The communication of socket current at 585 could involve a two-way exchange between sockets at ends of a power connection, and therefore both connected sockets could transmit their own socket current measurement and receive the socket current measurement from a remote socket to which it is connected.

In another embodiment of fault clearing, a current imbalance between currents within a single grid socket is used to detect a fault condition. In an example embodiment and referring to FIG. 5A, the current in grid socket 320_{I} is measured both by current sensing means 323 and 324. The two measurements could be compared by controller 330. A difference between the two measurements could indicate a ground fault in which one of conductors 156₁, 156₂ is connected to ground. In one embodiment an RMS current difference larger than a threshold value causes controllers 330 to open switches 321, 322, and isolate the fault.

Thus, in general, a power cable that couples together two power domains through respective grid sockets of the IDP in each power domain can be isolated from the two power domains by the switches of the grid sockets on sensing of a fault condition. A fault on a power connection within a power domain could similarly be isolated, at least at the IDP domain socket, in a similar matter. The controller in an IDP can control each of its socket, and specifically the switches therein, to isolate a power cable or connection from its internal power bus on sensing of a fault condition.

Each grid socket and/or domain socket could include a current sensor, or multiple current sensors, for sensing socket current. The fault condition could be any of those noted above, including an overcurrent condition sensed by the current sensor(s) of at least one of the sockets, and a current imbalance condition sensed by currents sensors of one socket or current sensors of multiple different sockets.

### Power Domain Connection to SFMG

The frequency and phase of power generation in a power domain should be synchronized with the frequency and phase of the SFMG it is connected to. In one embodiment, a power domain measures the voltage frequency and phase of the AC power on the SFMG prior to its connection to the SFMG using the voltage sensor(s) in one of the grid sockets of its IDP, through which the power domain would be connected to another power domain of the SFMG. If AC power is detected then the IDP controller communicates with the generator(s) in the power domain and synchronizes the frequency and phase of the generator(s) with the frequency and phase of the SFMG voltage measured by the voltage sensor(s), prior to connecting the power domain to the SFMG. If the IDP does not detect any AC power on the SFMG then it connects to the SFMG and becomes the first connected power domain. In terms of actual structure, the IDP voltage sensor(s) would be detecting voltage on a power cable that is connected to a grid socket, and connectivity between the power cable and the internal power bus of the IDP is controlled by the IDP controller using the socket switches.

When the next power domain attempts to connect to the SFMG it will detect the AC power of the first connected power domain and synchronize its power generation to it. It becomes the second connected power domain. When the next power domain attempts to connect to the SFMG it will detect the synchronized AC power of the first and second connected power domains and synchronize its power generation to them. The process can proceed as new power domains are synchronized and connected to the SFMG.

For example, referring to FIG. 1A, if power domain 120 wishes to connect to SFMG 100 through cable 158 it would measure the frequency and phase of the AC voltage at the IDP socket to which cable 158 connects and synchronize the frequency and phase of generator 126 to it. Referring to FIG. 3B, the frequency and phase of the SFMG voltage could be measured by voltage sensor 315 of socket 310_{I}. Referring to FIG. 3A, controller 330 could transmit the measured SFMG voltage frequency and phase information to generator 126 using communications means 350. Once the frequency and phase of generator 126 are synchronized, power domain 120 could connect to SFMG 100 by the closing of switches 311, 312 in socket 310_{I} by the controller 330.

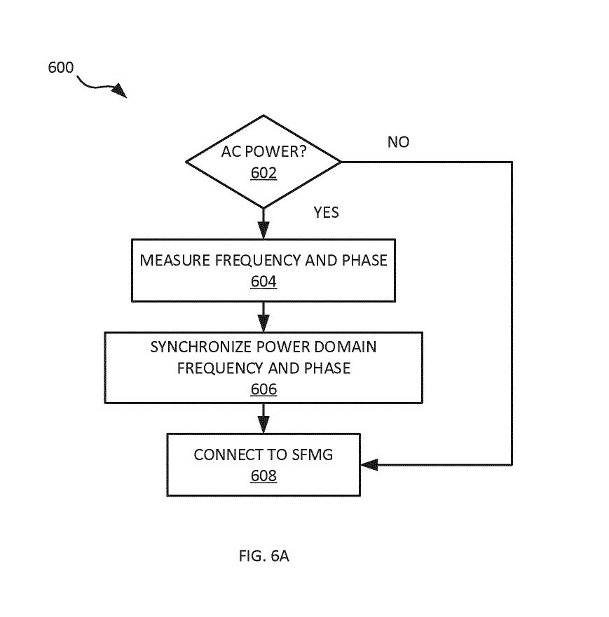

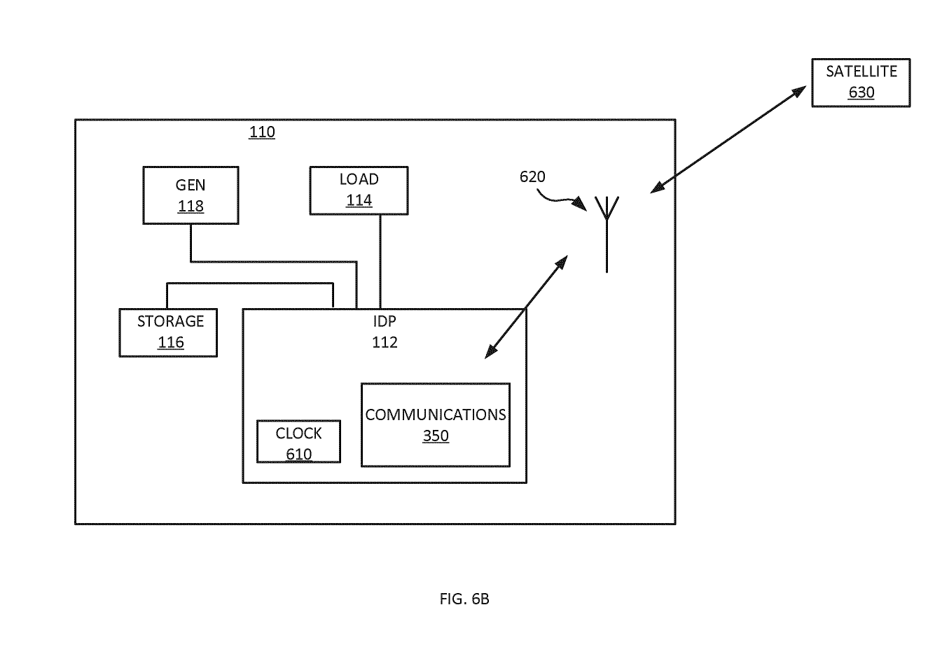

FIG. 6A is a flow diagram showing an example power domain connection method. At 602 the power domain controller determines whether AC power exists on the SFMG to which the power domain is to be connected. If YES at 602, then the frequency and phase of the AC power are measured at 604. At 606 the power domain frequency and phase are synchronized to the SFMG. At 608 the power domain is connected to the SFMG. If NO at 602 then the power domain connects to the grid at 608. Connection of the power domain to the SFMG involves no synchronization if there is no AC power on the SFMG.

In this type of synchronization approach, if a power domain goes off line and disconnects from the SFMG for any reason, there is no loss of synchronization between the remaining connected power domains. Synchronization is to the SFMG rather than to any particular power domain.

Synchronization of generator voltage frequency and phase to measured voltage frequency and phase at a grid socket represents one example of how IDPs, and specifically their controllers, could control operation of power domain components within their respective power domains based on or responsive to a condition of an electrical microgrid. Although the above example relates to generator control, IDP controllers could also or instead control electrical stores and/or loads based on microgrid conditions. It should also be noted that microgrid conditions other than voltage frequency and phase could be taken into account in a power domain component control scheme.

In another embodiment, each power domain has a unique delay before it attempts to connect to the SFMG. This embodiment may be useful for a “black start” in which all power domains are initially disconnected from the SFMG. This might be, for example, on first installation of the SFMG; after a general failure of the entire SFMG; or, in the case an entirely solar powered SFMG, in the morning when all power generation is just restarting.

In this embodiment each power domain or strictly its IDP controller, has a unique delay time or time interval during which it waits before attempting to connect to a power cable through which it may be connected to another power domain in the SFMG. In one embodiment the delay times are randomly generated and the delay range is such that the likelihood of two power domains having the same delay and attempting to connect simultaneously and become the first connected power domain is acceptably small. In this embodiment the simultaneous connection of remaining power domains is permissible since AC power will already have been established on the SFMG.

Other frequency and phase synchronization schemes are possible. In another embodiment each power domain in the SFMG contains an internal clock which is disciplined by an external clock signal to maintain its accuracy. Such clocks are well known and described by Yu in U.S. Pat. No. 6,725,157B1 “Indoor GPS Clock”. The internal clock could control the output frequency of the power domain generators to maintain it at the nominal grid frequency. A suitable clock signal might be derived, for example, from signals broadcast by the Global Positioning System (GPS) or other satellite based positioning system such as the European Galileo system, the Russian GLObal NAvigation Satellite System (GLONASS), the Indian Regional Navigational Satellite System (IRNASS). A regionally based time signal such as, the NIST WWVB time signal would also be suitable external clock.

Thus in one embodiment, each power domain in the SFMG has an antenna and an externally disciplined clock. Each power domain periodically receives and decodes the external clock timing signals to maintain the accuracy of its clock and synchronize all power domain clocks across the SFMG. In one embodiment the externally disciplined clock is part of the power domain's IDP. FIG. 6B is a block diagram of an example power domain with an externally disciplined clock. IDP 112 contains clock 610 and antenna 620. Antenna 620 receives an external clock signal from satellite 630 and relays it to communication module or means 350. In some embodiments antenna 620 is part of communication module or means 350. The external clock signal is also provided to clock 610, which could generate a synchronization clock signal, based on the external clock signal, for distribution to other components of the IDP 112 and/or power domain 110.

Other frequency and phase reference schemes are possible. In another embodiment one power domain in the SFMG is designated as the master power domain and broadcasts the clock signal. In one embodiment the master power domain is the first power domain to connect to the SFMG. The master power domain broadcasts a clock signal to the remaining power domains in the SFMG. The remaining power domains discipline their clocks to the master clock signal.

### Grid Tied Microgrid

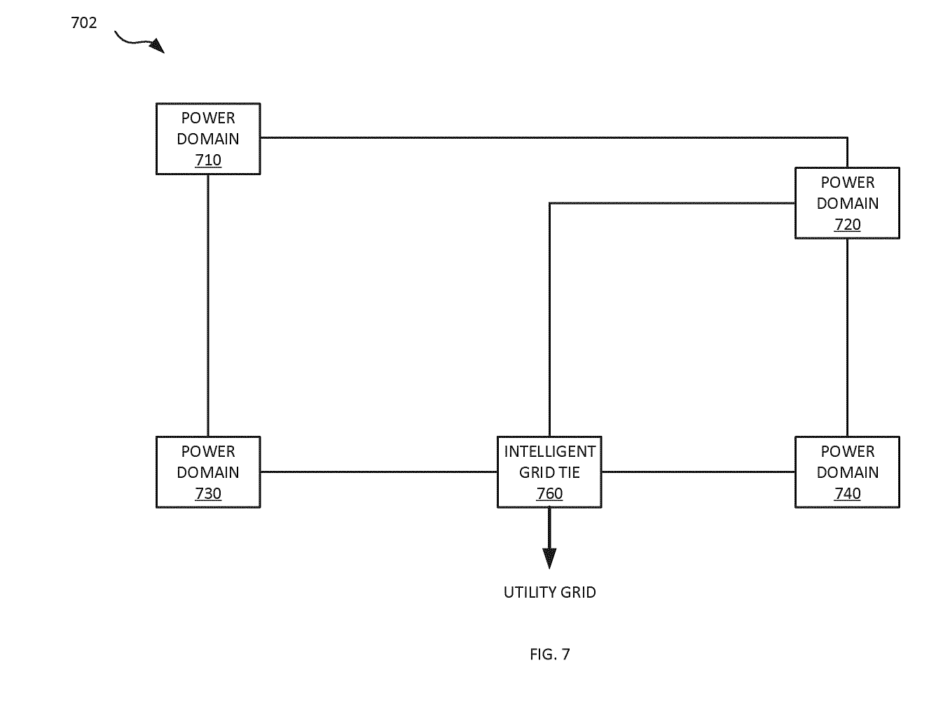

In the embodiments of FIG. 1A and FIG. 1B, the example SFMGs 100, 101 are not tied to and are thus isolated from a main electrical utility grid. In other embodiments however, an SFMG may connect to a main grid. FIG. 7 is a block diagram of an example SFMG connected to a main electrical grid. In this embodiment, example SFMG 702 connects to the main utility grid through an intelligent grid tie (IGT) 760 that is connected to the utility grid. Power can flow through the IGT 760 from the main grid to the SFMG 702 or from the SFMG to the main grid. IGT 760 could disconnect the SFMG 702 from the main grid in the event of a power outage on the main grid to maintain power on the SFMG and prevent formation of unwanted power islands on the main grid. IGT 760 could monitor the grid for a restoration of power after a disconnect and may reconnect the SFMG 702 to the grid once the grid is stable. The IGT 760 could be coupled to one power domain of the SFMG 702, or more than one power domain in the example shown, through respective power cables.

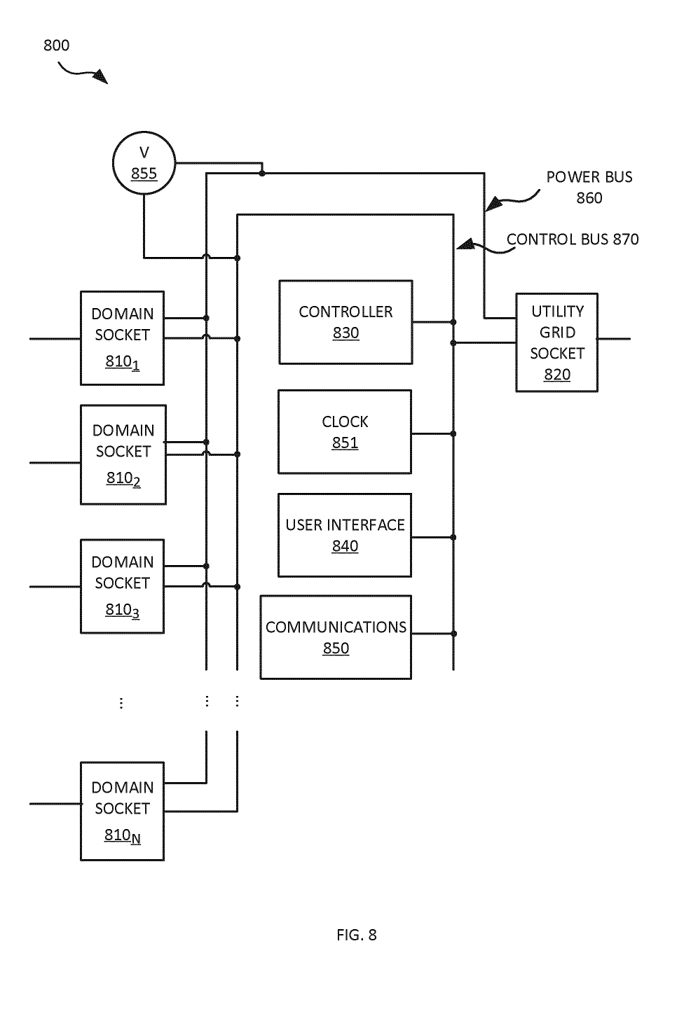

FIG. 8 is a block diagram of an example IGT. Example IGT 800 comprises power domain sockets 810₁, 810₂, 810₃, . . . 810_{N}, utility grid socket 820, controller 830, clock 851, user interface 840, communications module 850, internal power bus 860, control bus 870, and power bus voltage sensor or sense means 855 such as a voltmeter. Power domains connect to internal power bus 860 through power domain sockets 810₁, 810₂, 810₃, . . . 810_{N}. The example IGT 800 connects to the utility grid through utility grid socket 820. Connectivity of all sockets is controlled by controller 830 over control bus 870. Power is transferred between the utility grid and the power domains over internal power bus 360. Internal power bus 860 may be single-phase or multi-phase. In one embodiment internal power bus 860 is a single-phase AC bus that includes a power line and a neutral line. In another embodiment internal power bus 860 is a three-phase AC power bus that includes three power lines and a neutral line.

### Grid Stability

The voltage and frequency of an electrical grid will normally vary with its loading. One possible grid function is maintenance of the grid voltage and frequency within prescribed limits in the face of random fluctuations in demand. In a conventional grid the grid authority is responsible for maintaining grid stability. In an SFMG the grid stability function is distributed across the grid.

In one embodiment the IDPs of the SFMG monitor the grid voltage and frequency and adjust either the power output or the power consumption of their power domains to keep the grid voltage and frequency within acceptable values. This is another example of how IDPs, and specifically their controllers, might control operation of power domain components responsive to a condition of the electrical microgrid.

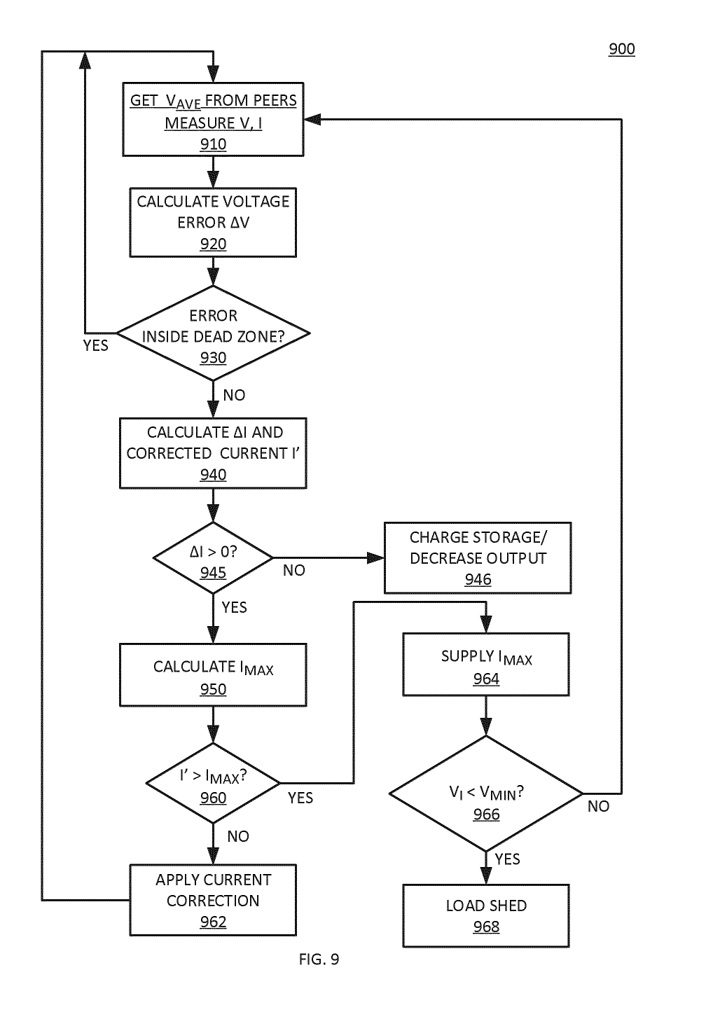

FIG. 9 is a flowchart illustrating an example output control method, for a power domain supplying power to the example SFMG of FIG. 1B. In the example method 900 the power domain's IDP receives voltage measurements from all other power domains in the SFMG at their connection points to the SFMG and the IDP controller calculates an average grid voltage V_{AVE} at 910. It also measures the voltage vᵢ at its own connection point to the SFMG. Power domain voltage measurement might be made by the power domain's IDP using any of its grid socket voltage sensors which are connected to the SFMG. The IDP controller then calculates a voltage error ΔV at 920.

The voltage error is the difference between the average voltage and the nominal grid voltage

V=V_{N}−V_{AVE}

where V_{AvE} is the average grid voltage and V_{N} is the nominal grid voltage. In North America, V_{N} might be, for example 120 volts.

A check is performed at 930 as to whether the voltage error is within a “dead zone” If the error is within the dead zone then no further action is taken. The dead zone range might be, for example from 5% above V_{N} to 5% below V_{N}. The dead zone prevents undesirable oscillation in the output of the power domain due to relatively small variations from the nominal grid voltage.

If the voltage error is outside the dead zone and positive then the average grid voltage is less than the nominal voltage and the IDP controller in the power domain will attempt to output more current to raise the average grid voltage. If the voltage error is negative then the average grid voltage is above the nominal voltage and the IDP controller in the power domain will attempt to reduce the output current of the power domain to decrease the average voltage.

An output current correction ΔIᵢ is calculated at 940. An example current correction ΔIᵢ that may be applied is

$$Δ {I}_{i} = K \frac{Δ V}{{V}_{i}} {I}_{i}$$

where Iᵢ is the domain output current, K is a constant that controls the system response. The corrected current domain output current I′ᵢ is then

I′ᵢ=Iᵢ+ΔIᵢ

and is also calculated at 940.

The current correction is evaluated at 945. If the current correction is negative, then the IDP controller in the power domain will decrease the power domain current output by reducing generated current or diverting current to charge power domain storage at 946.

If the current correction is positive, then the available output current of the power domain I_{MAX} is calculated at 950. The available output current is the sum of the available power domain generator currents and the available power domain storage device currents. In one embodiment the available generator current represents the maximum current that the generator(s) can supply. If the output of the generator(s) has been curtailed due to for example, lack of demand then the available generator current may exceed the amount being output.

In one embodiment the available current from a generator is set to a fraction of the maximum current it is capable of delivering. In this embodiment the current difference could then be used to provide emergency current during sudden transient events on the grid to prevent sudden voltage drops.

In one embodiment the available current from a storage device is a function of the percentage state of charge (SOC) of the storage device. In one embodiment the storage device has a maximum output current of I_{STOR,0} and the available storage current I_{STOR} is linearly dependent on SOC and given by the equation

I_{STOR}=SOC*I_{STOR,0}

For example, if the storage is fully charged then its SOC is 100% and the available storage current is equal to the maximum value. If storage is only 50% charged then the available storage current is 50% of its maximum.

In another embodiment the available storage current is dependent on the average grid voltage and increases with decreasing voltage. In one embodiment the dependence is linear and given by the equation

$${I}_{STOR} = {I}_{STOR , 0} \frac{{V}_{AVE} - {V}_{N}}{{V}_{N} - {V}_{MIN}} for {V}_{MIN} < {V}_{AVE} < {V}_{N}$$

Where V_{N} is the nominal grid voltage and V_{MIN} is a minimum allowable voltage and V_{N}>V_{MIN}. In this embodiment more storage current becomes available at lower grid voltages. Available storage current is a maximum when the average voltage equals V_{MIN} and zero when it equals V_{N}. In another embodiment the available storage current is a combination of the above two relationships.

A check is made at 960 that the corrected current does not exceed the available output current of the power domain. If the corrected current does not exceed the available current then the power domain output current is increased by changing the output current of the power domain generator(s) and/or storage device(s) at 962. If the corrected current will exceed the available output current then the maximum current is supplied at 964 and the power domain then evaluates the power domain voltage at 966. If the power domain voltage is less than a minimum value (V_{MIN}) then the power domain will shed some of its loads at 968. This might involve the IDP controller disconnecting one or more loads from the IDP internal power bus by controlling domain socket switches, and/or the IDP controller communicating with one or more loads to request a reduction in power consumption or load shutdown, for example.

The average grid voltage is continuously monitored by the IDP and the output current of the power domain continually adjusted in some embodiments. The foregoing is an example of a proportional control method in which the current correction value is proportional to the difference between the actual and nominal average grid voltages. More elaborate control methods such as a Proportional Integral (PI) or Proportional Integral Differential (PID) control are also possible.

### Load Shedding

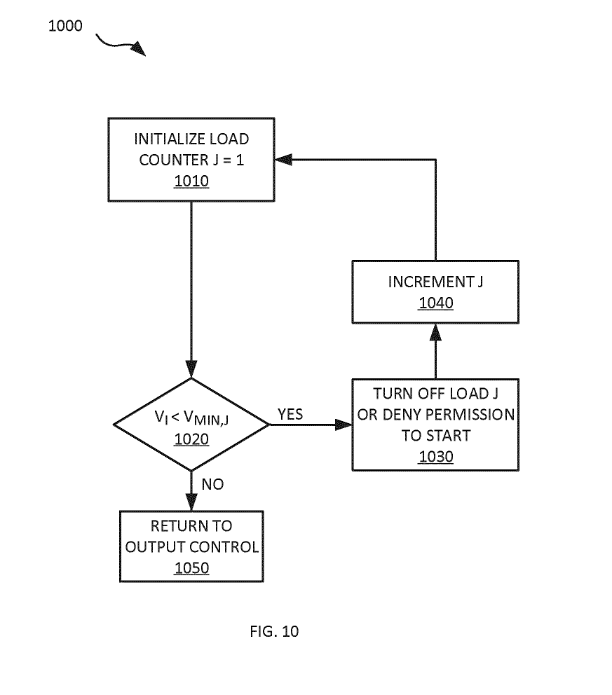

FIG. 10 is a flow chart illustrating an example load shedding method based on the grid voltage for a power domain containing N loads, L₁ to L_{N}. Loads are numbered in ascending order of priority with the first load L₁ having lowest priority and the highest load L_{N} having the highest priority in this example. Each load Lᵢ is assigned a turn-off voltage V_{TO,i}. Turn off voltages are inversely proportional to the load's priority. For example, a low priority load will have high turn-off voltage and a high priority load will have a low turn off voltage.

The example load shedding method 1000 involves initialization of the load counter “j” at 1010. At 1020 a comparison is made between the power domain voltage Vᵢ and the turn off voltage V_{TO,1} assigned to the first load L₁. If the power domain voltage is below the turn off voltage then at 1030 the IDP controller turns off the first load or removes its permission to start if it is not yet running. Turn off voltages are assigned in descending order with load L₁ having the highest turn off value, load L₂ the second highest and so on. For example V_{TO,1} might be 105V, V_{TO,2} might be 100V, V_{TO,3} might be 95V. Turn off voltages may be assigned by importance of the load. For example, communication equipment at a forward military base might be considered critical and assigned the lowest turn off voltage such that it will be the last load to be shed. An entertainment system might be assigned the highest turn off voltage such that it is the first load shed. Loads could be turned off or denied permission to start by opening the switches in the domain socket to which they connect or by communicating with the loads.

Counter j is incremented at 1040 and the next load is evaluated for shedding. Loads are turned off or denied permission to start until the power domain voltage is above the turn off voltage of the i-th load. The load shed sequence then terminates, and in the example shown there is a return to output control at 1050. Thus, the example method 1000 could be performed to shed load at 968 in the example method 900 of FIG. 9.

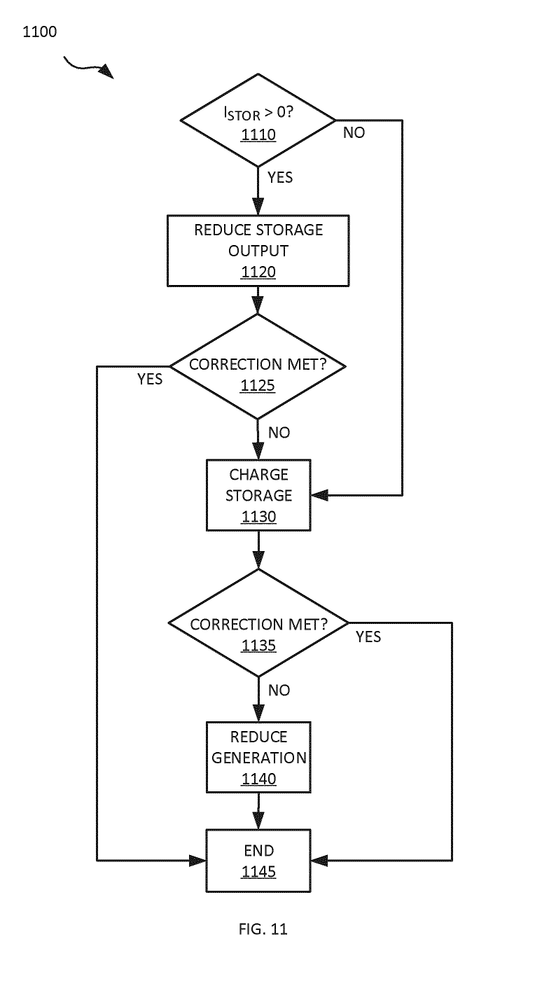

FIG. 11 is a flow chart showing an example output current reduction method. If the current correction ΔIᵢ calculated at 940 in example method 900 is negative then a check is made to see if there is any storage current output in the power domain at 1110. If there is storage output current then it is reduced at 1120 to attempt to meet the current correction. A current check is made at 1125. If the current correction was met then the method ends at 1145. If there was no storage current or reducing the storage current does not completely meet the current correction then current is diverted into the storage to charge it at 1130 to again attempt to meet the current correction. A check is made at 1135. If charging of storage cannot completely meet the current correction then generator output is reduced at 1140 to meet the remaining current correction. The method ends at 1145.

The foregoing are only examples of a possible control method and more elaborate control methods are possible. For example proportional integral differential control methods might be used instead of proportional methods.

### CONCLUSION

What has been described is merely illustrative of the application of principles of embodiments of the present disclosure. Other arrangements and methods can be implemented by those skilled in the art.

For example, embodiments could include further, fewer, and/or different components/operations than those explicitly shown in the drawings, interconnected/performed in a similar or different order than shown. A controller's memory, for instance, is noted above but not explicitly shown in the drawings. Such a memory could include one or more solid state memory devices, and/or memory devices that use movable or even removable storage media.

In addition, although described primarily in the context of methods and systems, other implementations are also contemplated, as instructions stored on a non-transitory computer-readable medium, for example. Thus, it should be appreciated that at least some features could be implemented using hardware, firmware, components which execute software, or some combination thereof. Electronic devices that might be suitable for implementing such features disclosed herein include, among others, microprocessors, microcontrollers, Programmable Logic Devices (PLDs), Field Programmable Gate Arrays (FPGAs), Application Specific Integrated Circuits (ASICs), and other types of “intelligent” integrated circuits.

1. An electrical microgrid comprising:
a plurality of autonomously controlled power domains;
power cables coupling said plurality of power domains together,
each of said power domains comprising an intelligent distribution panel, said power domains being coupled to said power cables through said intelligent distribution panels
wherein each of said power domains comprises:
at least one of: an electrical load, an electrical generator, and an electrical store,
said at least one of an electrical load, an electrical generator, and an electrical store that comprises a power domain being coupled to said intelligent distribution panel of said power domain.

2.-3. (canceled)

4. The electrical microgrid of claim 1 wherein said electrical microgrid is isolated from a utility grid.

5. The electrical microgrid of claim 1, further comprising:
an intelligent grid tie connected to a utility grid;
a further power cable coupled between said intelligent grid tie and a power domain of said plurality of power domains.

6. (canceled)

7. The electrical microgrid of claim 1 wherein each of said intelligent distribution panels of each of said power domains comprises:
at least one domain socket for connection to said at least one of an electrical load, an electrical generator, and an electrical store within said respective power domain;
at least one grid socket for connection to another of said power domains through a respective one of said power cables;
an internal power bus coupled to said at least one domain socket and to said at least one grid socket; and
a controller for switchably connecting said at least one of an electrical load, an electrical generator and an electrical store to said internal power bus through said at least one domain socket and for switchably connecting said respective one of said power cables to said internal power bus through said at least one grid socket.

8. The electrical microgrid of claim 7 wherein each of said intelligent distribution panels further comprises a communications module for enabling communication with any one or more of said at least one of an electrical load, an electrical generator, and an electrical store within said respective power domain, with another one of said power domains, or both within said power domain and with another one of said power domains.

9. The electrical microgrid of claim 7 wherein each of said intelligent distribution panels controls operation of said at least one of an electrical load, an electrical generator, and an electrical storage within its respective power domain responsive to a condition of said electrical microgrid.

10. The electrical microgrid of claim 7 wherein each of said at least one grid socket of each of said intelligent distribution panels comprises:
switches for switchably connecting said internal power bus to a respective one of said power cables.

11. The electrical microgrid of claim 10 wherein one of said power cables, coupling together two of said power domains through respective grid sockets of said Intelligent distribution panels of said two of said power domains, is isolated from said two of said power domains by said switches of said respective grid sockets on sensing of a fault condition.

12. The electrical microgrid of claim 11 wherein each of said at least one grid socket of each of said intelligent distribution panels further comprises:
current sensors for sensing a grid socket current,
wherein said fault condition is an overcurrent condition sensed by said current sensors of at least one of said respective grid sockets of said intelligent distribution panels.

13. The electrical microgrid of claim 11 wherein each of said at least one grid socket of each of said intelligent distribution panels further comprises:
current sensors for sensing a grid socket current,
wherein said fault condition is a current imbalance condition sensed by said current sensors of said respective grid sockets.

14. The electrical microgrid of claim 11 wherein each of said at least one grid socket of each of said intelligent distribution panels further comprises:
current sensors for sensing a grid socket current,
wherein said fault condition is a current imbalance condition sensed by said current sensors of one of said respective grid sockets.

15.-16. (canceled)

17. The electrical microgrid of claim 1 wherein said power cables are of identical rated current carrying capacity.

18. (canceled)

19. An intelligent distribution panel comprising:
a plurality of sockets to enable connection of said intelligent distribution panel to one or more components within a power domain and to one or more other power domains through respective power connections;
an internal power bus coupled to said plurality of sockets;
a controller coupled to said plurality of sockets, to control connectivity of said one or more components and said respective power connections with said internal power bus.

20. (canceled)

21. The intelligent distribution panel of claim 19, said one or more components within said power domain comprising at least one of: an electrical load, and electrical generator, and an electrical store.

22. The intelligent distribution panel of claim 19, further comprising:
a communications module for enabling communication with a component of said one or more components within said power domain, with a power domain of said one or more other power domains, or both with a component of said one or more components within said power domain and with a power domain of said one or more other power domains.

23. The intelligent distribution panel of claim 19, said controller controlling a socket of said plurality of sockets to isolate a power connection of said power connections from said internal power bus on sensing of a fault condition.

24. The intelligent distribution panel of claim 23, each socket of said plurality of sockets comprising:
current sensors for sensing a socket current, said current sensor coupled to said controller,
wherein said fault condition comprises: (i) an overcurrent condition sensed by said current sensors of said socket of said plurality of sockets; or (ii) a current imbalance condition sensed by (a) said current sensors or by (b) said current sensors and current sensors of a socket of an intelligent distribution panel in a power domain of said one or more other power domains.

25.-26. (canceled)

27. The intelligent distribution panel of claim 19, each socket of said plurality of sockets comprising:
a current sensor for sensing a socket current, said current sensor coupled to said controller.

28. The intelligent distribution panel of claim 19, said plurality of sockets comprising a socket to enable connection of said intelligent distribution panel to a power connection that comprises a power line and a neutral line, said socket comprising:
a first current sensor for sensing a power line socket current at said socket;
a second current sensor for sensing a neutral line socket current at said socket.

29.-30. (canceled)

31. The intelligent distribution panel of claim 19, the plurality of sockets comprising a socket that further comprises:
a voltage sensor for sensing a voltage at a power connection of said respective power connections.

32. The intelligent distribution panel of claim 19, said plurality of sockets comprising a socket to enable connection of said intelligent distribution panel to a power connection that comprises a power line and a neutral line, said socket comprising:
a voltage sensor for sensing a voltage between said power line and said neutral line.

33.-34. (canceled)
